(19) United States
(12) Patent Application Publication
(10) Pub. No.: US 2006/0049824 A1
(43) Pub. Date: Mar. 9, 2006

(54) Sensor with low bulkiness for detecting determined position of a mobile

(75) Inventors: Rainer Moller, Chaponnay (FR); Laurent Dufour, Meximieux (FR); Olivier Andrieu, Beynost (FR)

Correspondence Address: DENNISON, SCHULTZ, DOUGHERTY & MACDONALD, 1727 KING STREET, SUITE 105, ALEXANDRIA, VA, 22314, US

(73) Assignee: Electricfil Automotive

(21) Appl. No.: 11/188,101

(22) Filed: Jul. 25, 2005

(30) Foreign Application Priority Data
Jul. 27, 2004 (FR) 04 08272

(51) Int. Cl. G01B 7/30

(52) U.S. Cl. 324/207.2

(57) ABSTRACT

The sensor according to the invention is characterized in that: the bulkiness of the coding tracks is less than the measuring stroke of the measuring stroke of the mobile,
the detection elements (6a, 6b) are sensitive to the value of the physical quantity of the coding elements, so that each detection element occupies a first binary state when the value of the physical quantity is larger than a threshold, a second binary state when the value of the physical quantity is less than said threshold, one of the two determined binary states when said detection elements are not found located opposite a coding track, and
at least one coding track (10a, 10b) includes, as a coding element, at least one first type coding element (11ᵥ) on the one hand, and at least one second type coding element (11a, 11b) on the other hand.

### BACKGROUND OF THE INVENTION

The object of the invention relates to the technical field of sensors suitable for locating different linear positions assumed by a mobile in the general sense.

The object of the invention is more specifically directed to the technical field of sensors of the magnetic type for detecting the positions of a mobile.

The object of the invention finds a particularly advantageous application in the field of motor vehicles in order to fit out an automatic gearbox with it in order to detect the gears selected by an operator.

In the preferred technical field of the invention, selection of the different positions of an automatic gear box is performed from a lever generally controlled in rectilinear displacement by the operator. With such a lever, it is possible to select different positions, such as for example a park position, a reverse position, a neutral position or different forward drive positions. Conventionally, the selection lever acts on a hydraulic control rod or drawer placed in the hydraulic circuit in order to allow selection of the desired position of the automatic gear box.

In the state of the art, various technical solutions have been suggested for locating the different positions assumed by the selection lever or the control drawer. For example, U.S. Pat. No. 5,307,013 describes a position sensor including a mobile coder connected to the control member and having several coding tracks extending parallel to the displacement axis. Each of the tracks is formed with magnetic north and south coding poles. These coding elements are arranged on the track so that detection sensitive cells, mounted relatively to the coding tracks, deliver a different combination of binary signals for each determined position of the mobile.

Such a sensor allows the different linear positions assumed by a mobile such as a selection lever of an automatic gearbox, to be recognized from different combinations of binary signals. This magnetic sensor has the advantage of operating without any relative mechanical friction between the coder and the detection cells. However, such a sensor has a major drawback related to its bulkiness. Indeed, the length of the coder is at least equal to the measuring stroke as the coder exhibits the physical image of the code. The bulkiness of the sensor which corresponds to the distance assumed by the coder between its two extreme displacement positions is equal to at least twice the stroke of the mobile in which the positions are to be determined.

In the same sense, a position sensor is known from U.S. Pat. No. 4,584,472 with which a multiplicity of positions of a control member of a vehicle may be detected. Such a sensor includes coding tracks extending relatively to detection elements borne by a mobile support. The detection elements are shifted relatively to each other in order to allow their relative positioning. However, the bulkiness of the sensor which corresponds to the distance taken by the support between these two extreme displacement positions is equal to at least twice the stroke of the support in which the positions are to be determined.

U.S. Pat. No. 6,100,681 describes a position sensor including a magnet moving relatively to a first series of detection cells and to a second series of detection cells. The cells of the second series are shifted by a value equal to a quarter of a period allowing counting and detection of the displacement direction. However, with such a sensor, it is not possible to detect the absolute position of the mobile element. Further, such a sensor does not deliver a different combination of binary signals for each of the detected positions.

### SUMMARY OF THE INVENTION

The object of the invention is therefore directed to finding a remedy to the drawbacks of the prior art by proposing a sensor capable of accurately detecting the different positions provided by a mobile, while having a limited bulkiness.

To achieve this goal, the sensor according to the invention includes:
a coder, connected to the mobile and having at least two coding tracks extending parallel to the displacement axis, each of the tracks being formed with coding elements with a physical quantity,
detection elements mounted relatively to the coding tracks and suitable for delivering a different combination of binary signals for each determined position of the mobile.
   The sensor is characterized in that:
the bulkiness of the coding tracks is less than the measuring stroke of the mobile,
the detection elements are sensitive to the value of the physical quantity of the coding elements, so that each detection element occupies:
   a first binary state when the value of the physical quantity is larger than a threshold,
   a second binary state when the value of the physical quantity is less than said threshold,
   one of the two determined binary states when said detection elements are not found located opposite a coding track,
at least one coding track includes, as coding elements, at least one coding element of a first type which allows a detection element placed opposite it to deliver a determined binary state identical with the one delivered when said detection element is not found opposite a coding track, on the one hand, and at least one coding element of the second type which allows a detection element placed opposite it, to deliver a binary state different from the one delivered when said detection element is found opposite a coding element of the first type on the other hand.

To further limit the bulkiness, provision may be made so that the coding elements of the tracks are arranged so that at least two of them, belonging to different tracks, are set back along the displacement axis, so that the coder has bulkiness less than twice the stroke of the mobile.

In order to increase the number of detections of the position of the mobile, without increasing the bulkiness, provision may be made so that at least one coding track is found fitted out with at least two detection elements shifted relatively to each other, along the displacement axis.

According to a preferred alternative embodiment, the coder includes tracks formed with coding elements of the magnetic type while the detection elements are monopolar detection cells.

According to this preferred alternative embodiment, the tracks are formed with coding elements including as coding elements of the second type, magnetic poles having a same polarity, on the one hand, so that the detection elements placed opposite occupy a determined binary state and, as coding elements of the first type, non-magnetic poles or magnetic poles with a sign opposite to the sign of the constitutive magnetic poles of the coding elements of the second type on the other hand, so that the detection elements placed opposite occupy the other determined binary state.

Advantageously, each end magnetic pole of each track is bordered with a magnetic contrast pole.

Another advantage of the object of the invention is to propose a sensor of different types, so that the coder includes tracks formed with coding elements of the electrical, capacitive, or inductive type, whereas the detection elements are detection elements of the electrical, capacitive or inductive type, respectively.

### BRIEF DESCRIPTION OF THE DRAWINGS

Various other features emerge from the description made below with reference to the appended drawings which show embodiments of the object of the invention as non-limiting examples.

FIG. 1 is a simplified perspective view showing an exemplary embodiment of a sensor according to the invention.

FIG. 2 is a transverse sectional view taken along FIG. 1 showing the characteristic elements of the sensor according to the invention.

FIG. 3 is a diagram which explains the constitutive principle of the sensor according to the invention, including two coding tracks.

FIG. 4 is a diagram of another embodiment of the sensor according to the invention.

FIG. 5 is a time diagram corresponding to the sensor illustrated in FIG. 4.

FIG. 6 is a table showing the different logical combinations delivered by the detection elements according to the sensor illustrated in FIG. 4.

FIG. 7 illustrates another feature of the embodiment of the sensor according to the invention.

### DESCRIPTION OF THE PREFERRED EMBODIMENTS

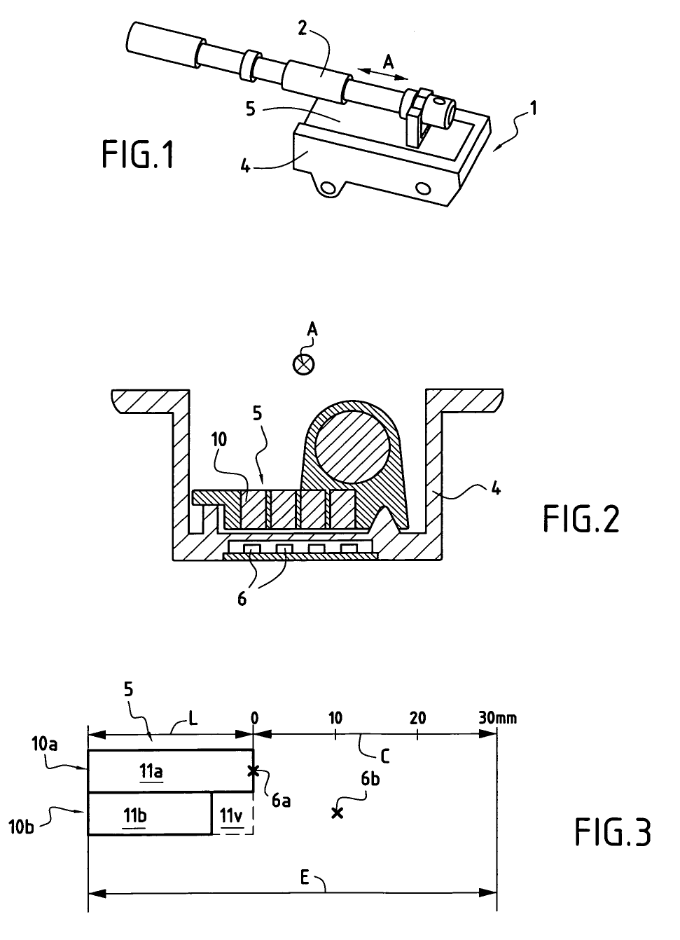

FIGS. 1 and 2 schematically illustrate an exemplary embodiment of a sensor 1 suitable for detecting the positions of a mobile 2 moving linearly along a displacement axis A. The mobile 2 has a determined measuring stroke C, in which the positions of the mobile are to be detected. For example, the mobile 2 is a control rod inserted into the hydraulic control circuit of an automatic gearbox, in the general sense. The sensor 1 includes a supporting and guiding case 4 arranged in order to provide the displacement, along the displacement axis A, of a coder 5 attached to the mobile 2. The coder 5 is mounted so as to move relatively to detection elements 6 fixedly mounted on the support 4. The coder 5 has at least two and, in the example illustrated in FIG. 2, four coding tracks 10 extending parallel to each other and to the displacement axis A and each moving past at least one detection element 6. Each track 10 is formed with coding elements 11 according to a determined physical quantity, arranged so that the detection elements 6 deliver a different combination of binary signals for each determined position of the mobile 2.

Subsequently in the description, the coder 5 is of the magnetic type, so that the coding elements 11 have a magnetic character and the detection elements 6 are magnetic detection cells, such as Hall effect cells, for example. Of course, the object of the invention may be applied to a position sensor making use of a different physical quantity. Thus, the sensor may be of the electrical, capacitive or inductive type, so that the tracks 10 of the coder are formed with the coding elements of the electrical, capacitive or inductive type, whereas the detection elements 6 are detection elements of the electrical, capacitive or inductive type, respectively.

The detection elements 6 are sensitive to the value of the physical quantity of the coding elements 11, so that each detection element 6 occupies:
a first binary state when the value of the physical quantity is less than a threshold,
a second binary state when the value of the physical quantity is larger than said threshold,
a determined (first or second) binary state when said detection elements 6 are not found located opposite a coding track 10.

According to another feature of the invention, at least one coding track 10 includes, as coding elements 11, at least one coding element of a first type 11ᵥ which allows a detection element 6 placed opposite said component to deliver a determined binary state, identical with the one delivered when said detection element 6 is not found opposite a coding track on the one hand and at least one coding element of the second type 11ᵢ (with i=a, b, . . . ) which allows a detection element 6 placed opposite to deliver a binary state different from the one delivered when said detection element is found opposite a coding element of the first type 11ᵥ on the other hand. It should be noted that the bulkiness of the coding tracks 10 is less than the measuring stroke C of the mobile 2.

In the case of the embodiment of a sensor of the magnetic type, the coding elements of the second type 11a, 11b of the tracks are achieved by magnetic poles of the same polarity, whereas the coding elements of the first type 11ᵥ are made by non-magnetic poles playing the same role as an absence of the coding track or by magnetic poles with a sign opposite to the sign of the constitutive magnetic poles of the coding elements of the second type. The detection elements 6 are made with monopolar Hall effect cells.

According to another feature of the invention, the detection elements 6 are shifted relatively to each other relatively to each other along the displacement axis A. In other words, the detection elements 6 are not found located in a same plane traverse to the displacement axis A.

With FIG. 3, the principle of the sensor 1 according to the invention including a coder 5 with two coding tracks 10a, 10b may be explained. With this sensor, it is possible to detect three positions of the mobile 2 by means of two detection elements of the magnetic type 6a and 6b each assigned to a coding track 10a and 10b. The coder 5 thus includes a track 10a formed by a determined magnetic pole 11a, for example a north pole, and has a length L equal to 20 mm. In the illustrated example, the bulkiness of the coder 5 is equal to the length L of the track 10a, as this will appear in the description subsequently. The track 10b is formed by a magnetic pole 11b, with the same polarity as the pole 11a and for example, by a non-magnetic pole 11ᵥ. The non-magnetic pole 11ᵥ in the illustrated example has a length of 5 mm, whereas the magnetic pole 11b has a length of 15 mm, so that the track 10b also has a length of 20 mm.

Taking into account the shift of the detection elements 6a and 6b, equal to 10 mm in the illustrated example, location of the three positions of the mobile 2 may be achieved according to the description which follows. For a displacement of the coder 5 between 0 and 15 mm, the detection elements 6a, 6b are in different binary states. To simplify the description, a detection element is considered as occupying a first binary state (equal to 1, for example) when a magnetic pole is located opposite and a second binary state (equal to 0 in the example) when the detection element is placed opposite a non-magnetic pole 11ᵥ or outside a coding track. In the relevant example, the detection elements 6a, 6b respectively occupy binary states 1 and 0, between 0 and 15 mm of the coder's stroke. For a stroke located between 15 and 20 mm, the detection elements 6a, 6b are placed opposite magnetic poles, so that the binary code is 11. For a stroke located between 20 and 30 mm, the detection cell 6a is placed outside the coding track 10a, so that the binary code is 01. It is to be noted that the binary code is 00 before the 0 mm position as well as after the 30 mm position, and may be considered as information outside the measuring stroke.

In the description above, it is to be noted that the displacement of the coder 5 has a stroke C limited to 30 mm, so that the bulkiness E of the sensor is equal to this stroke C increased by the length L of the coder, i.e. equal to 50 mm. It should therefore be noted that this bulkiness E of the sensor is less than twice the stroke of the coder, to the extent that the coding tracks 10a, 10b, i.e., the coder, have a smaller length L than the measuring stroke C.

It is to be noted that the coding elements 11a, 11b of the tracks 10a, 10b, are arranged so that at least two of them, belonging to different tracks, are set back along the displacement axis, in order to optimize the bulkiness of the sensor. It should be considered that a shift of origin of one of the tracks is performed. Also, the associated detection elements 6a, 6b are shifted along the A axis, in the same direction as the coding elements with the same value.

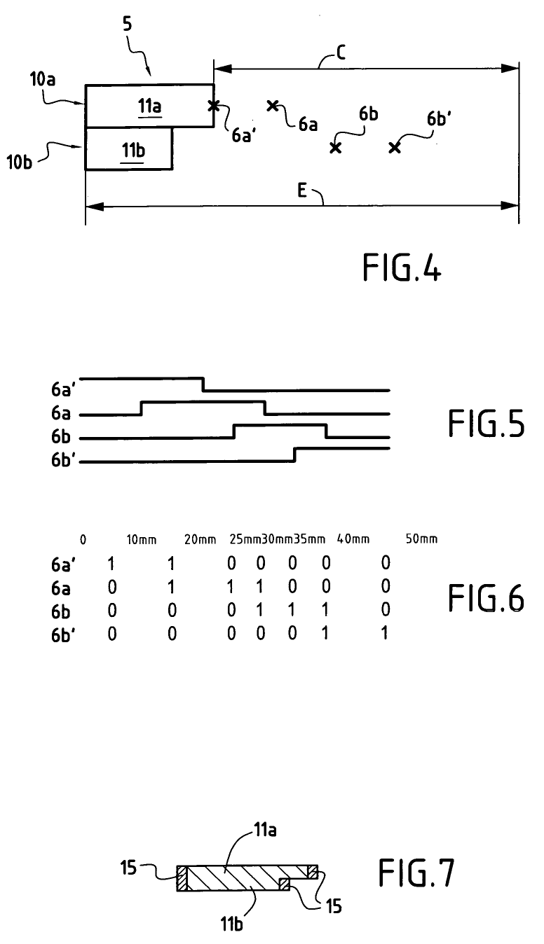

FIGS. 4 to 6 illustrate a sensor 1 applying an enhancement aimed at detecting a number of extra positions for the mobile 2. According to this exemplary embodiment, at least one, and, in the illustrated example, both coding tracks 10a, 10b are each provided with at least two detection elements (6a, 6a′; 6b, 6b′, respectively) shifted relatively to each other along the displacement axis A, in order to increase the number of detections of the positions of the mobile. It is thus possible to code seven positions on both existing tracks instead of the three initially possible positions (FIG. 3). In this example, the coding track 10a is provided with a shifted detection element 6a′ upstream relatively to the detection element 6a, considering the direction of the stroke C schematized in FIG. 4. Likewise, the position sensor 1 also includes a detection element 6b′, shifted relatively to the detection element 6b along the displacement axis A, downstream relatively to the direction of the stroke C. In this exemplary embodiment, the detection elements 6a, 6a′ for the coding track 10a and the detection elements 6b, 6b′ for the coding track 10b are each shifted by a value of 10 mm. As this more specifically emerges from FIGS. 5 and 6, it is thus possible to code seven positions on four bits by only using two coded tracks. In the illustrated example, the maximum stroke C is 50 mm for a coder 5 measuring 20 mm and moving opposite to detection elements 6a, 6a′, 6b, 6b′, the most spaced out of which are 30 mm apart. The total bulkiness of the sensor does not exceed 70 mm.

In the examples described above, the coder 5 includes two tracks 10. Of course, the coder 5 may include a larger number of tracks, for example equal to four, two of which move relatively to the two detection elements. Such a coder includes suitably arranged coding elements and has extra magnetic poles for optimizing the number of tracks and/or detection elements. It is thus possible to detect, for example thirteen positions of the 2 with four tracks relatively to which six detection elements are mounted.

FIG. 7 illustrates a preferred embodiment wherein each end magnetic pole 11a, 11b of each track is bordered, at each of its ends, with a magnetic contrast pole 15 for example achieved by a magnetic pole with a sign opposite to the magnetic pole 11a, 11b or by a polar plate. With the contrast pole 15, which has a small length, for example from 1 to 2 mm, it is possible to improve the accuracy of the transitions of each track by increasing the transition slope in the vicinity of the switching point for the detection element. With this contrast pole, it is thereby possible to reduce the switching positioning dispersion due to the threshold dispersion of the detection element and/or of the gap.

The invention is not limited to the described and illustrated examples since different changes may be provided without departing from its scope.

What is claimed is:

1. A sensor for detecting determined positions of a mobile (2) moving along a displacement axis (A), with a determined measuring stroke (C), the sensor including:
a coder (5), connected to the mobile and having at least two coding tracks (10) extending parallel to the displacement axis, each of the tracks being formed with coding elements (11) with a physical quantity,
detection elements (6) mounted relatively to the coding tracks and suitable for delivering a different combination of binary signals for each determined position of the mobile,
characterized in that:
the bulkiness of the coding tracks (10) is less than the measuring stroke of the mobile,
the detection elements (6) are sensitive to the value of the physical quantity of the coding elements, so that each detection element occupies:
a first binary state when the value of the physical quantity is larger than a threshold,
a second binary state when the value of the physical quantity is less than said threshold,
one of the two determined binary states when said detection elements are not found located opposite a coding track,
at least one coding track (10) includes, as a coding element (11), at least one coding element of a first type (11ᵥ) which allows a detection element placed oppositely to deliver a determined binary state identical with the one delivered when said detection element is not found opposite to a coding track on the one hand, and at least one coding element of the second type (11ᵢ) which allows a detection element placed opposite to deliver a binary state different from the one delivered when said detection element is found opposite a coding element of the first type, on the other hand.

2. The sensor according to claim 1, wherein the coding elements (11) of the tracks are arranged so that at least two of them, belonging to different tracks, are set back along the displacement axis, so that the coder (5) has a bulkiness less than twice the stroke of the mobile.

3. The sensor according to claim 1, wherein one of the coding tracks (10) is provided with at least two detection elements (6) shifted relatively to each other along the displacement axis (A), so as to increase the number of detections of the positions of the mobile.

4. The sensor according to claim 1, wherein the coder (5) includes tracks (10) provided with magnetic type coding elements, whereas the detection elements are monopolar detection cells.

5. The sensor according to claim 4, wherein tracks (10) are formed with coding elements (11) including as second type coding elements, magnetic poles (11ᵢ) having a same polarity, on the one hand, so that the detection elements (6ᵢ) placed opposite occupy a determined binary state and, as first type coding elements, non magnetic poles (11ᵥ) or magnetic poles with a sign opposite to the sign of the constitutive magnetic poles of the second type coding elements, on the other hand, so that the detection elements (6ᵢ) placed opposite, occupy the other determined binary state.

6. The sensor according to claim 5, wherein each end magnetic pole (11ᵢ) is bordered with a magnetic contrast pole (15).

7. The sensor according to claim 1, wherein the coder (5) includes tracks (10) formed with coding elements of the electrical, capacitive, or inductive type, whereas the detection elements are detection elements of the electrical, capacitive or inductive type, respectively.
